(19) United States
(12) Patent Application Publication
(10) Pub. No.: US 2016/0029688 A1
(43) Pub. Date: Feb. 4, 2016

(54) Compression Plate Ejection Technology

(71) Applicant: Weidenmiller Company, Itasca, IL (US)

(72) Inventors: RICH PAUL BUDEK, Elmhurst, IL (US); STEPHEN J. KRAS, Chicago, IL (US)

(21) Appl. No.: 14/811,224

(22) Filed: Jul. 28, 2015

Related U.S. Application Data
(60) Provisional application No. 62/030,585, filed on Jul. 29, 2014.

(51) Int. Cl. A23P 1/10

(52) U.S. Cl. CPC A23P 1/105

(57) ABSTRACT

A molding tool ejection technology utilizing manifolded air to eject food stuff from a cavity of a mold plate. The cavities include orifices. The orifices are aligned with the channel such that air and gas in the channel exits the orifices. The orifices are assembled with porous inserts. The porous inserts have an exterior surface that have a contour that is continuous with the surface of the cavity floor, including any design etching existing thereon. Air entering the channel is ejected from the orifices, creating force acting on the contents of the cavity thereby causing ejection. The air ejection technology may be coupled with mechanical ejection technology.

### RELATED APPLICATIONS

The present patent document claims the benefit of the filing date under 35 U.S.C. §119(e) of Provisional U.S. Patent Application Ser. No. 62/030,585, filed Jul. 29, 2014, which is hereby incorporated by reference in its entirety, including all drawings and documents filed therewith.

### BACKGROUND

Consumers increasingly rely upon the convenience of packaged food products. Convenience foods for both animals and humans have proliferated—and range from healthy to indulgent. Consumables such as but not limited to cookies, candies, crackers, and animal nourishment, come in a variety of textures, compositions, shapes, and sizes. Rotary die cutters and rotary die molds are a popular method of forming consumable food products, however, rotary die cutters and rotary die molds may not be optimal for creating three dimensional food items.

### BRIEF SUMMARY

A compression plate and ejection technology is disclosed. A compression plate may include a first plate and a second plate. The first plate and second plate may include mold cavities therein. The mold cavities may include ejection orifices. The ejection orifices may receive air from air channels running beneath the mold cavities. The ejection orifices are in fluid communication with the air channels. The ejection orifice contains a porous material. The porous material is inserted into the mold cavities such that it forms a continuous uninterrupted surface in the plane of the mold cavities, including any pattern that may be present. In a variation, the entire mold cavity and/or an entire surface of the ejection plate may be made of a porous material.

Other features and advantages of the disclosure will be, or will become, apparent to one of skill in the art upon examination of the following figures and detailed description. It is intended that all such additional advantages and features be included in the description, be within the scope of the invention, and be protected by the claims.

### BRIEF DESCRIPTION OF THE DRAWINGS

FIG. 1 provides an exemplary mold tool in an open conformation;

FIG. 2 provides an exemplary mold tool in a closed conformation;

FIG. 3A provides an exemplary blow up of a section of a mold tool;

FIG. 3B provides an exemplary isolated plug;

FIG. 4 provides an exemplary plug assembled with an orifice;

FIG. 5 provides a second exemplary plug assembled with an orifice;

FIG. 6 provides an exemplary mold plate showing channels;

FIG. 7 provides a second exemplary mold tool in a open conformation;

FIG. 8A provides a cross section of a second exemplary mold tool in a closed conformation;

FIG. 8B provides a cross section of a variation of a second exemplary mold tool in a closed conformation;

FIG. 9A provides a further cross section FIG. 8A;

FIG. 9B provides a view of a disassembled porous insert;

FIG. 10A provides a cross section view of a mold plate having a mold cavity;

FIG. 10B provides a variation of the mold plate having a mold cavity of FIG. 10A;

FIG. 10C provides a cross section of the mold plate of FIG. 10B in a closed conformation with a second mold plate;

FIG. 11 provides a cross section view of a mold plate having a mold cavity and a mechanical ejection site;

FIG. 12 provides a cross section view of a mold plate having a mold cavity and a mechanical ejection site;

FIG. 13A provides a sectional view of a mechanical ejection device assembled with a mold cavity;

FIG. 13B provides a sectional view of a variation of the mechanical ejection device assembled with a mold cavity of FIG. 13A;

FIG. 14 provides a sectional view of a first mold plate having a mold cavity having a mechanical ejection site assembled with a second mold cavity having a mechanical ejection site;

FIG. 15A provides a sample plate;

FIG. 15B provides a disassembled sample plate;

FIG. 16 provides a cross section of a mold plate assembled with a porous insert;

FIG. 17 provides a view of a the mold plate of FIG. 16 with the porous insert removed; and

FIG. 18 provides a second view of the mold plate of FIG. 16 with the porous insert removed.

### DETAILED DESCRIPTION OF THE DRAWINGS

Food products of various kinds, including cookies, crackers, candies, animal consumables, and other products, are frequently formed by high-volume automated rotary mold and/or rotary cutting devices. Consumers are increasingly interested in three-dimensional food items. We disclose a compression food product mold, which may create three dimensional food products with good fidelity and efficiency.

In an industrial process of manufacturing three dimensional food items, a food product dough may be introduced into a forming mold. The forming mold may be configured, e.g., with surface contours, etchings, and similar structural elements, to create a three dimensional product with an aesthetic appearance. For example, a cookie, cracker or treat with a design on both sides, a cookie, cracker or treat in the shape of an object (e.g., an automobile, a dog, a fish, a flower, a baby pacifier, and etc.).

Several processes are used to release the formed product from the molding tool. Some use fat and lard as lubricants to discourage attachment of the food product to the molding tool. With the rising popularity of fat-free products, the industry increasingly adopted molding tool coatings to assist release of formed shapes. Examples of molding tool coatings include formulations of TEFLON and ceramics, including but not limited to, those that are FDA and USDA approved for food contact.

Many known coatings wear out from repeated use; therefore the molding tools require routine maintenance. As the molding tool coatings wear out, the release fidelity decreases. Coatings may wear out over time and require re-application. In some examples, the coating release performance may be inversely related to coating wear performance. Product increasingly sticks to the surface of the molding tool. Decreases in fidelity result in considerable expense due to lost food product (e.g., through deformations, and sticking), down time, and loss of efficiency. Furthermore, the maintenance process results in downtime. Maintenance requires removing the subject machine from operation while the molding tool is removed for reconditioning. The reconditioning process takes several days to several weeks and bears a significant expense. In an attempt to realize a large product output despite the maintenance inefficiencies, many companies are required to run several machine lines so that they can rotate production and maintenance. This requires larger more expensive facilities to house redundant machinery.

We disclose a molding tool and ejection technology that is capable of operating at high efficiency with minimal maintenance. In one variation, the molding tool ejection technology eliminates the requirement of tool coatings. In a variation, the molding tool ejection technology eliminates the requirement of the use of lubricants, including by increasing the fat content of the food product. In a variation, the technology may provide a inhibit sticking of candy dough, which may have increased tackiness over cookie, cracker, or treat dough, and which may not be responsive to lubricants and coatings. In a variation, the molding tool ejection technology features a molding tool with no internal moving parts, further reducing maintenance concerns. The reduction of moving parts further increases the sanitation of the system, as moving parts often create additional surfaces in which food product may be trapped.

We also disclose a novel method of employing a porous material within the molding tool technology. In one variation, the porous material may be a porous metal material that has inter-connected porosity. A porous metal material may be fabricated from metal powder particles using powder metallurgy techniques. The porous material may have a range of pore sizes from about 0.2 micrometer to about 200 micrometers.

Definitions

Definitions: unless stated to the contrary, for the purpose of the present disclosure the following terms shall have the following definitions:

A reference to “another variation” in describing an example does not imply that the referenced variation is mutually exclusive with another variation unless expressly specified.

The terms “a,” “an” and “the” mean “one or more,” unless expressly specified otherwise.

The phrase “at least one of” when modifying a plurality of things (such as an enumerate list of things) means any combination of one or more of those things, unless expressly specified otherwise.

The term “represent” and like terms are not exclusive, unless expressly specified otherwise. For example, the term “represents” does not mean “represents only,” unless expressly specified.

The term “e.g.” and like terms means “for example, but not limited to” and thus does not limit the term or phrase it explains.

The term “porous material” may be a porous metal material that has inter-connected porosity. A porous metal material may be fabricated from metal powder particles using powder metallurgy techniques. The porous material may comprise synthetic materials, ceramics, or combinations and composites thereof. The porous material may be a sintered material or may be a micro-drilled material. The porous material may have a range of pore sizes (whether created by a sintering process or by micro-drilling) from about 0.05 micrometer to about 300 micrometers. For example, the porous material may have a pore size in the range in micrometers of about 0.05-300, 0.5-300, 0.2-100, 5.0-30, 20-40, or any individual value or range falling in between the listed ranges. Additionally or alternatively, the pore size within a porous material may vary throughout the material or the porous material may include pores of more than one pore size within the disclosed ranges. A porous insert is an insert made of a porous material.

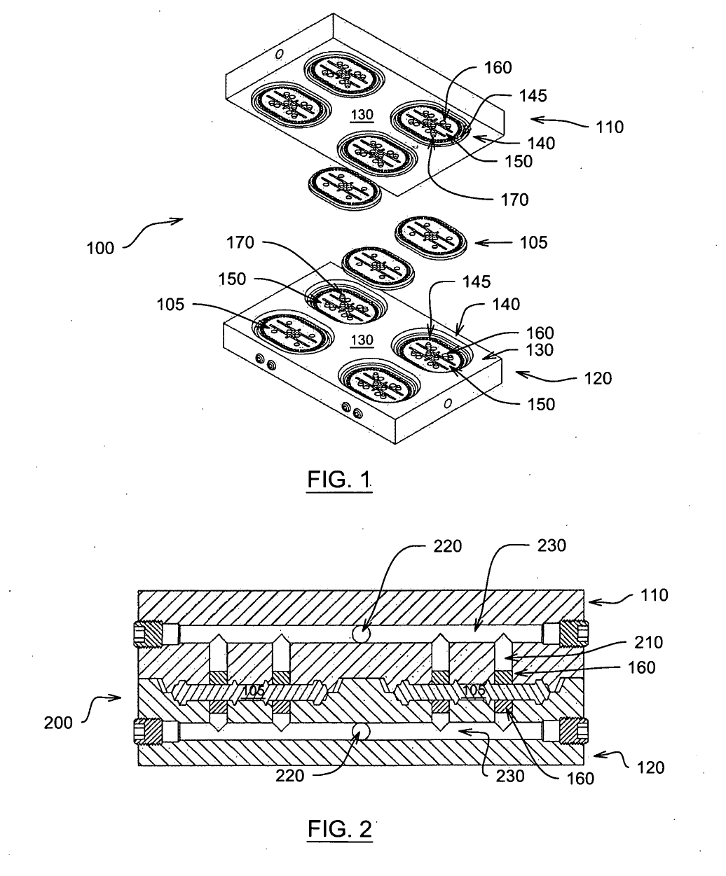

FIG. 1 illustrates a first variation of a mold tool 100. A three dimensional consumable 105 may be shaped by a mold structure. A mold structure may include a first plate 110 and a second plate 120. The first plate 110 and/or second plate 120 may be constructed of, for example but not limited to, aluminum, steel, copper, or other suitable metal or non metal material. In a variation, the first plate 110 and/or second plate 120 may be constructed entirely or partially of a porous material. The mold structure may have a single cavity or may have as many cavities as is practical. FIG. 1 illustrates a four-cavity mold for convenience and ease of illustration. While the first plate 110 and/or second plate 120 are shown with complementary cavities capable of creating 3-D products, it should be understood that the disclosed technology can be applied to a single plate construction (e.g., which may be filled with product dough and then scraped) or a construction in which either the first plate 110 or the second plate 120 are flat and therefore create a product with a contoured side and a flat side.

To illustrate, a first non-limiting basic method of creating a three dimensional cookie, on which we shall later elaborate, may have the following steps. A mold structure is provided. The mold may have a first plate 110 and a second plate 120. Each of the first plate 110 and the second plate 120 may have at least one mold cavity 140. The mold cavity 140 may be applied to the first plate 110 and/or second plate 120 by, e.g., etching, milling, EDM (electrical discharge machining), molding, or engraving processes.

The mold cavity 140 of the first plate 110 may align with the mold cavity 140 of the second plate 120. During use, a mass of a dough material is placed into an open mold cavity 140 of the first plate 110 and/or the second plate 120. The dough material may be temperature optimized for compression. The first plate 110 and the second plate 120 are placed into a closed formation. The closed formation aligns the mold cavity 140 of the first plate 110 with the mold cavity 140 of the second plate 120 such that mass of dough material is formed into a shape matching the contour of the aligned mold cavities. (A dough material is a term that refers to the pre-cooked/pre-dried/pre-hardened/pre-solidified format of the ultimate consumable 105). The mold is opened and the resulting three dimensional consumable may drop freely from the mold.

We provide a novel technological improvement, which may reduce or eliminate the use of coatings, lubricants, and dough ingredients (e.g., fats) while maintaining or improving ejection efficiency. The reduction or elimination of the use of coatings may also be accomplished while improving the fidelity of the resulting consumable. For example, the resulting consumable made by the disclosed novel technology may have good consistency, be substantially free of unintended deformities, and achieve structural subtleties (such as sharp contours and raised peaks) not achievable under currently known methods.

The first plate 110 and the second plate 120 may have similar general features, depending on the geometry of the desired end product. FIG. 1 illustrates a mold device for creating a largely symmetrical end product (e.g., the first side and second side have the same general features). It should be understood that the design elements of the first plate 110 and the second plate 120 may differ, resulting in an end product with a first side that has different features from the back side (e.g., front side may have a design and the back side may be smooth). For example, the first plate 110 and the second plate 120 may have mirror-image symmetry, and/or the plates may differ from each other.

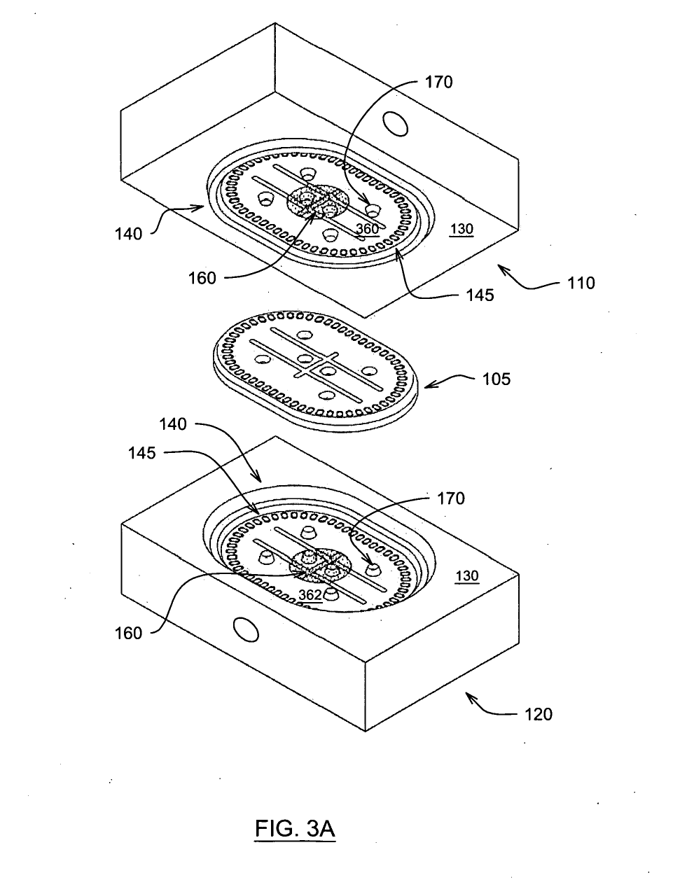

The following description may be applicable to one or both of the first plate 110 and the second plate 120. A first plate 110 may have a plate surface 130. The plate surface 130 may have a mold cavity 140 therein. Alternatively or additionally, the first plate 110 may be engineered such that the mold cavity 140 is situated above the plane of the molding face surface 130. The mold cavity 140 may include side wall 145 and a floor 150. In a variation, the side wall 145 may rise above the plane of the molding face surface 130. The floor 150 of the mold cavity 140 may include a porous insert, which may be a plug 160 assembled with an orifice FIG. 2, 210. FIG. 1 illustrates four plugs 160; however, fewer or more plugs 160 may be employed without departing from the claims. The floor 150 may also include docker pins 170 emerging therefrom.

The second plate 120 may have a surface 130. The surface 130 may have a mold cavity 142. The mold cavity 140 may include a side wall 145 and a floor 150. The floor 150 of the mold cavity 140 may include a porous insert, which may be a plug 160 made of a porous material. FIG. 1 illustrates four plugs 160, however, fewer or more plugs 160 may be employed without departing from the claims. The floor 150 may also include docker pins 170 emerging therefrom.

FIG. 2 provides a cross section view of a closed mold. The cross section is taken through a cavity 140. A first plate 110 may be assembled with a second plate 120 to form a closed conformation. In the closed conformation, a consumable 105 is formed by the compression of the mold cavity 140 of the first plate 110 with the mold cavity 140 of the second plate 120. The mold cavity 140 of the first plate 110 may include an orifice 210. The orifice 210 may be disposed beneath the mold cavity 140 and in fluid communication with the mold cavity 140. The orifice 210 may include a plug 160 inserted therein. As discussed above, the plug 160 may be made of a porous material. The plug 160 may be inserted into the orifice 210 such that a surface of the plug 160 is continuous with the floor 150 of the mold cavity 140. The porous structure of the plug 160 may have the advantage of preventing the dough product from being caught or trapped in the orifice 210 of the mold cavity 140.

The first plate 110 may include a distribution channel 230 and a source channel 220. The distribution channel 230 may be in fluid communication with one or more orifice 210. The distribution channel 230 may receive fluid (including air and gas) from a source channel 220. Alternatively or additionally, the distribution channel and/or orifice 210 may receive fluid (including air and gas) directly from an air source. The pressure differential inside the distribution channel 230, the orifice 210 and/or the source channel 220 in the plate and the atmospheric pressure may create a force that acts on the consumable 105, releasing or ejecting the consumable 105.

In one example, a pore size of about 5 micrometers to about 50 micrometers may permit air to flow from the distribution channel 230 through the plug 160 assembled into the orifice 210, providing an ejection force on any consumable 105 present. The plug 160 may additionally or alternatively vent the cavity, which may improve product fidelity by relieving entrapped air from the cavity. Entrapped air may prevent good packing. Good packing of dough into the cavity improves product quality and shape.

A pore size of about 5 micrometers to about 50 micrometers may have the additional or alternative property of prohibiting the flow of dough (e.g., dough, cookie dough, cracker dough, candy paste, and other food material) back into the plug 160 and/or orifice 210.

The plug 160 may create a discrete strategically located portion of the floor 150 of the mold cavity 140. Ejection air may pass from the orifice 210 through the plug 160 to enter the mold cavity 140 and force the release of consumable 105. The plug 160 permits long-term use of the mold tool 100 without the concern of fouling of the plug 160. To the extent that the combined use of the plug 160 with the air ejection technology reduces or eliminates the need for coatings and/or lubricants, the system introduces considerable economic efficiencies. The mold tool will require less maintenance, which will result in less down time. With a reduction in down time, manufacturers can reduce their floor space, as they may need fewer manufacturing lines to accomplish the same output.

Mold cavities 140 may include design contour (e.g., on the floor 150 and/or side walls 145) so that a design may be imparted to the consumable 105. Where the mold cavity 140 includes contour, the exterior surface of the plug 160 may also contain a contour such that there is no interruption in the design and the plug 160 exterior surface is continuous with the floor 150 of the mold cavity 140. While reference is made to the numerals of the first plate 110, the description may apply to the second plate 120.

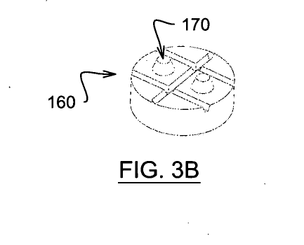

FIG. 3A is a view of a single mold cavity 140. This variation is merely illustrative of the robust system, illustrating plugs 160 that contain surface contour. FIG. 3B shows an isolated plug. A first plate 110 may include a mold cavity 140. The mold cavity 140 may have a side wall 145 and a floor 150. The floor 150 may be above or below the plane of the plate surface 130.

The mold cavity 140 may include a porous insert, such as a plug 160. The plug 160 may be assembled with an orifice (not shown). The floor 150 may include a contour, which may impart a design on the consumable 105. The mold cavity 140 may include a docker pin 170, e.g., a docker pin 170 arising from the floor 150. The mold cavity may include a porous insert, which may be a plug 160. The plug 160 may have an exterior surface including a contour. The contour may create a continuity of design. The plug 160 may include a docker pin 170. In one variation, the plug 160 may be manufactured to include the docker pin 170.

A second plate 120 may include a mold cavity 140. The mold cavity 140 may have a side wall 145 and a floor 150. The floor 150 may be above or below the plane of the plate surface 130.

The floor 150 may include a contour, which may impart a design on the consumable 105. The plug 160 may have an exterior surface including a contour. The contour may create a continuity of design. The plug 160 may include a docker pin 170. In one variation, the plug 160 may be manufactured to include the docker pin 170.

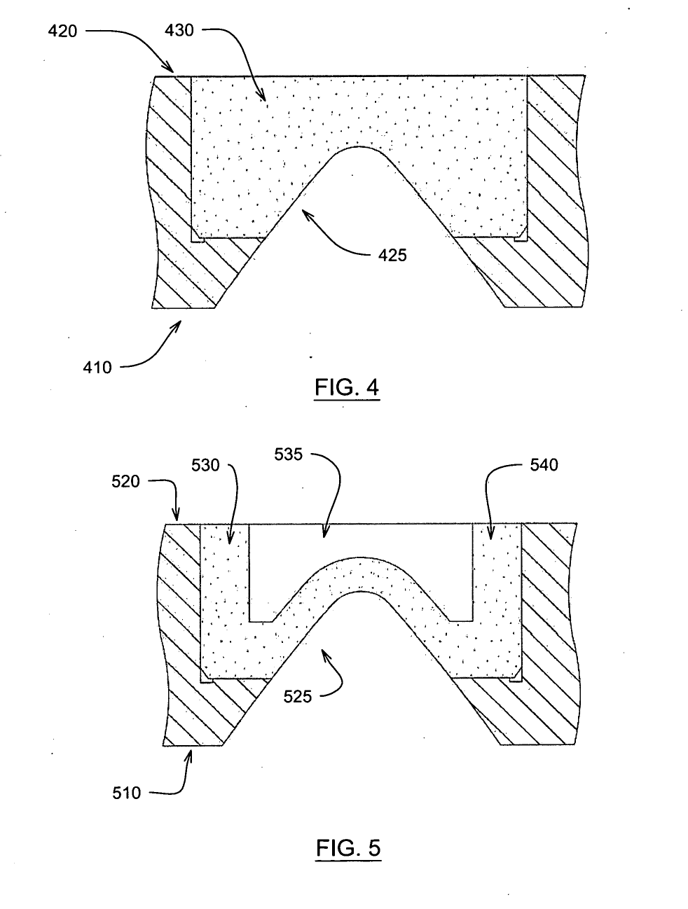

FIG. 4 provides an alternate construction of a plug 160. It shows an exploded close up of a cross section of a mold plate having a surface face 410. A mold plate may include a contour 425 on or integrated with the surface face 410. The mold plate may include a porous insert, which may be a plug 430. The plug may be contoured to compliment the contour 425 of the surface face 410. The plug 430 may be constructed to a final shape prior to insertion. Alternatively or additionally, the plug may be constructed as a near net shape, which is fit and retained into an orifice of a mold cavity. The plug may be finished for smooth matching contour after insertion.

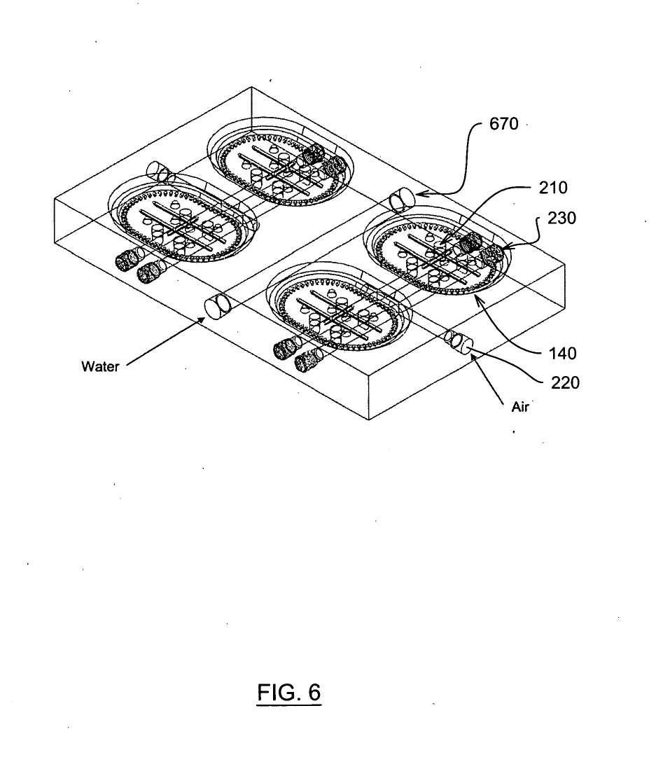

FIG. 5 provides an alternate construction of a porous insert. It provides a magnified cross section of a mold plate having a surface face 510. A mold plate may include a contour 525 on or integrated with the surface face 510. The mold plate may include a porous insert, which may be plug 530. The plug 530 may be contoured to compliment the contour 525 of the surface face 510. The plug 530 may be constructed to a final shape prior to insertion. Alternatively or additionally, the plug may be constructed as a near net shape, which is fit and retained into an orifice of a mold cavity. The plug may be finished for smooth matching contour after insertion. The plug 530 may define an opening 535, which may be a void space. The plug 530 may include sidewalls 540 which may have constant thickness or may have variable thickness. For example, reducing the thickness of a sidewall may increase air flow due to a reduced pressure drop for air flow through the porous insert.

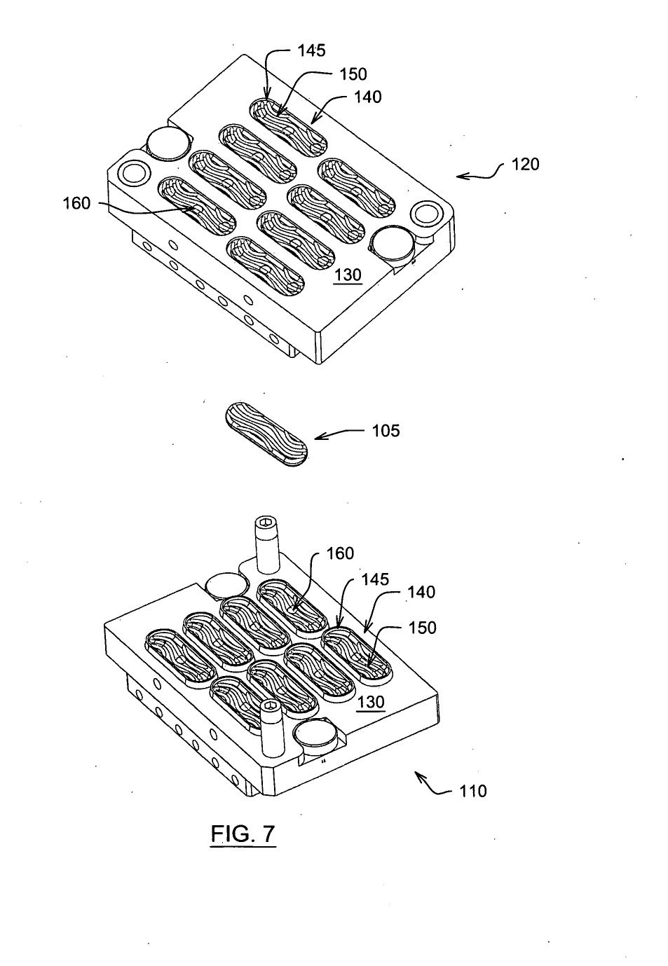

FIG. 6. A forming mold may additionally or alternatively include a temperature regulation channel 670. The temperature regulation channel 670 may permit fluid circulation. The fluid circulated may be a temperature modifying solution. The fluid may provide, e.g., heating or cooling of the forming mold. Temperature modification of the forming mold may effect product ejection.

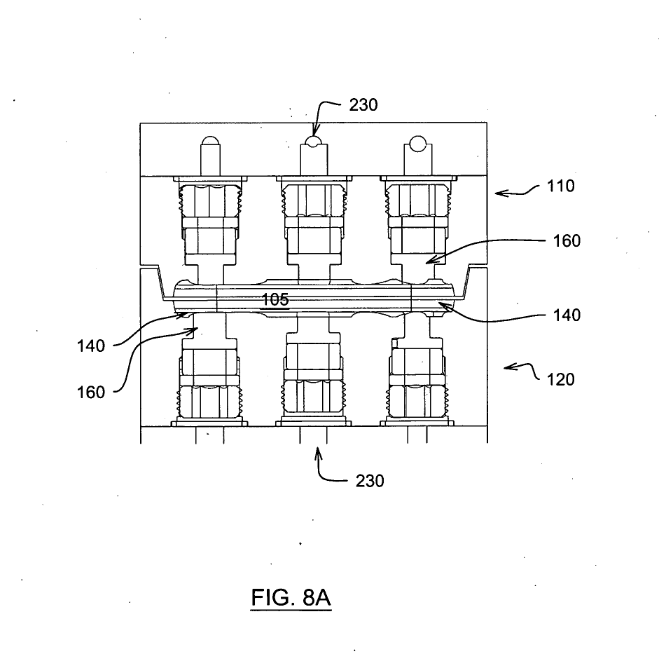

FIG. 7 illustrates a second variation of a mold tool. A three dimensional consumable 105 may be shaped by a mold structure. A mold structure may include a first plate 110 and a second plate 120. The first plate 110 and/or second plate 120 may be constructed of, for example but not limited to, aluminum, steel, copper, or other suitable metal or non-metal material. In a variation, the first plate 110 and/or second plate 120 may be partially or fully constructed of a porous material. The mold structure may have a single cavity or may have as many cavities as is practical. FIG. 7 illustrates an eight-cavity mold for convenience and ease of illustration.

Each of the first plate 110 and the second plate 120 may have at least one mold cavity 140. The mold cavity 140 of the first plate 110 may align with the mold cavity 140 of the second plate 120. The mold cavity 140 of the first plate 110 and/or mold cavity 140 of the second plate 120 may be capable of receiving a mass of a dough material. The dough material may be temperature optimized for compression. When the first plate 110 and the second plate 120 are placed into a closed formation, the mold cavity 140 of the first plate 110 may align with the mold cavity 140 of the second plate 120 such that mass of dough material is formed into a shape matching the contour of the aligned mold cavities.

To illustrate, a second non-limiting basic method of creating a three dimensional cookie, on which we shall later elaborate, may have the following steps. A mold structure is provided. The mold may have a first plate 110 and a second plate 120. Each of the first plate 110 and the second plate 120 may have at least one mold cavity 140. The mold cavity 140 of the first plate 110 may align with the mold cavity 140 of the second plate 120. The first plate 110 and the second plate 120 are placed into a closed formation. The closed formation aligns the mold cavity 140 of the first plate 110 with the mold cavity 140 of the second plate 120 such that a three dimensional space is created within the closed mold. A dough material is delivered into the three dimensional space of the closed mold, e.g., in an open conformation, the dough material may be loaded into the first plate 110 and/or the second plate 120, and/or the dough material may be loaded into a closed mold. When the mold is opened and the resulting three dimensional consumable may drop freely from the mold, assisted as described herein.

The following description of the mold cavity 140 be applicable to one or both of the first plate 110 and/or second plate 120. For example, the first plate 110 and/or second plate 120 may have mirror-image symmetry, and/or the plates may differ from each other. A first plate 110 may have a surface 130. The surface 130 may have a mold cavity 140 machined below the plane of the surface 130. Alternatively or additionally, the first plate 110 may be engineered such that the mold cavity 140 is situated above the plane of the surface 130. The mold cavity 140 may include side wall 145 and a floor 150. In a variation, the side wall 145 may rise above the plane of the molding face surface 130. The floor of the mold cavity 140 may include a porous insert, which may be a plug 160. FIG. 1 illustrates three orifices 160, however, fewer or more orifice 160 may be employed without departing from the claims. (While described only for the first plate, the features listed above may exist either on the first plate, the second plate, or both).

The second plate 120 may have a surface 130 and a mold cavity 140 therein. The mold cavity 140 may include side wall 145 and floor 150. The floor 150 of the mold cavity 140 may include a porous insert, such as a plug 160.

FIG. 7 illustrates four plugs 160 per mold cavity 140, however, fewer or more plugs 160 may be employed without departing from the claims. It shall be seen that in FIG. 7, the side walls 145 may form a continuous contour with the floor 150. The designation of “walls” and “floor” are merely used to roughly delimit the elements of the mold cavity such to allow a more precise description of the location of the orifices, design elements, and etc.

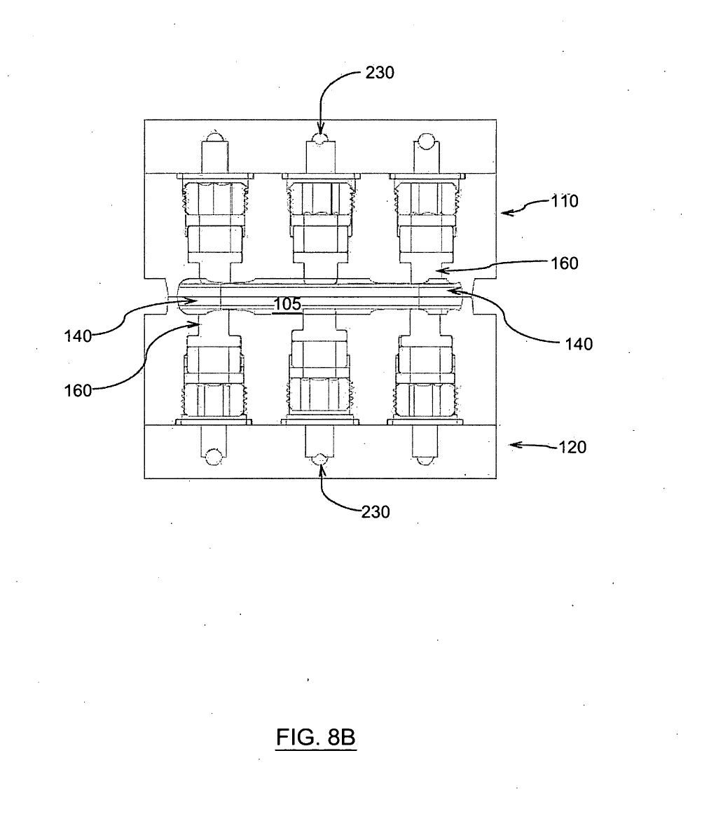

FIG. 8A provides a cross section view of a closed mold of the second variation introduced at FIG. 7. This view provides a cross section view of the porous insert. The cross section is taken through a mold cavity 140. A first plate 110 may be assembled with a second plate 120 to form a closed conformation. In the closed conformation, a consumable 105 is formed by the compression of the mold cavity 140 of the first plate 110 with the mold cavity 140 of the second plate 120. The mold cavity 140 of the first plate 110 may include a porous insert, which may be a plug 160. The plug 160 may be inserted into the orifice 210 such that the plug 160 is continuous with the floor 150 of the mold cavity 140.

The first plate 110 may include a distribution channel 230. The distribution channel 230 may be in fluid communication with one or more orifice 210 (not shown) in which the plug 160 is fit and retained. The distribution channel 230 may receive fluid (including air and gas) from a source channel (see, e.g., FIG. 2, 220). Alternatively or additionally, the distribution channel and/or orifice 210 may receive fluid (including air and gas) directly from an air source. The pressure differential inside the distribution channel 230 in the plate and the atmospheric pressure may create a force that acts on the consumable 105, releasing or ejecting the consumable 105.

In FIG. 8A, the plug 160 forms a small, strategically located portion of the floor 150 of the mold cavity 140. Air from the distribution channel 230 passes through the plug 160 supplying ejection air to the mold cavity 140 to force the release of consumable 105. The plug 160 permits long-term use of the mold tool 100 without the concern of fouling of the plug 160. To the extent that the combined use of the plug 160 with the air ejection technology reduces or eliminates the need for coatings and/or lubricants, the system introduces considerable economic efficiencies. The mold tool will require less maintenance, which will result in less down time. With a reduction in down time, manufacturers can reduce their floor space, as they may need fewer manufacturing lines to accomplish the same output.

FIG. 8A provides a first plate 110 which has a raised guide wall and a second plate 120 which has a recessed guide wall. In a closed conformation, the raised guide wall of the first plate 110 may interact with the recessed guide wall of the second plate 120. The disclosure is not limited to this form of interaction of the first plate 110 with the second plate 120. For example, FIG. 8B demonstrates a variation of a first plate 110 and a second plate 120 in a closed conformation. The first plate 110 and the second plate 120 may interact directly without the implementation of raised and/or recessed guide walls.

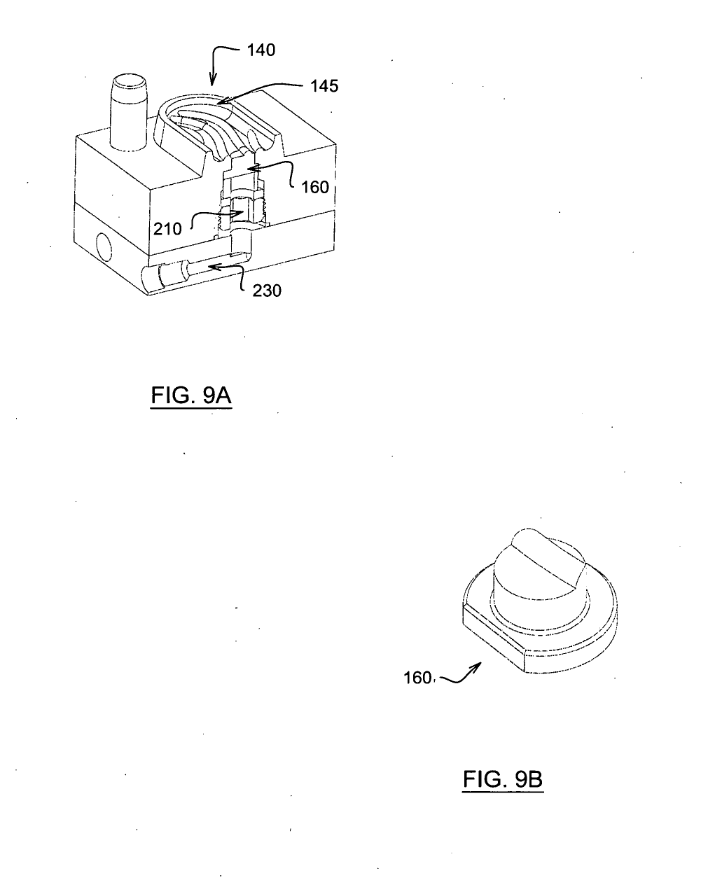

FIGS. 9A and 9B provide a second cross section view through a mold cavity 140 of a first plate. It should be understood that the principals of FIGS. 9A and 9B may be applied to mold cavities 140 of a second plate 120. Mold cavity 140 may include contour so that a design may be imparted to the consumable 105. Where the mold cavity 140 includes contour, the plug 160 may be engineered to contain a contour such that there is no interruption in the design. For example, the plug 160 exterior surface is continuous with the floor 150 of the mold cavity 140. While reference is made to the numerals of the first plate 110, the description may apply to the second plate 120. FIG. 9b demonstrates a porous insert plug 160. The plug 160 is disassembled from the orifice 210 to demonstrate the contour of the plug 160.

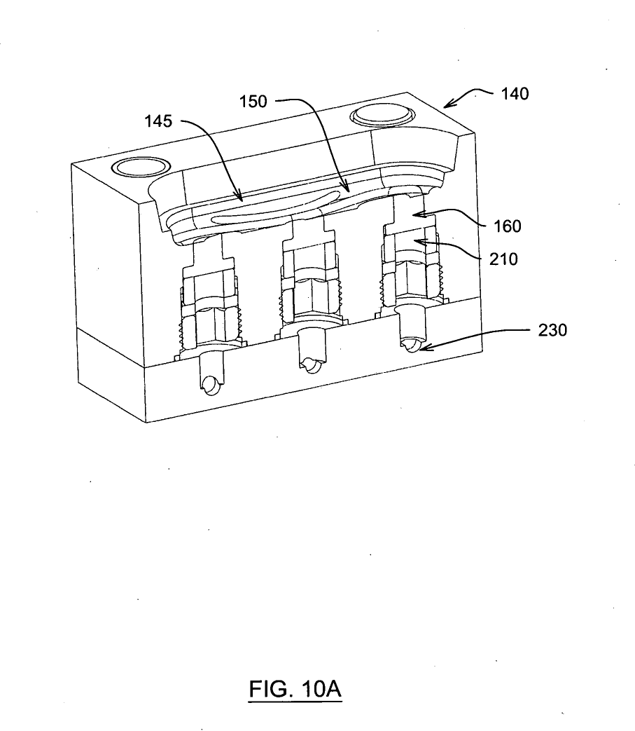

FIG. 10A provides an additional section view of a mold cavity plate with a mold cavity 140. Mold cavities 140 may include contour so that a design may be imparted to the consumable 105. Where the mold cavity 140 includes contour, the plug 160 may be machined to contain a contour such that there is no interruption in the design and the plug 160 exterior surface is continuous with the floor 150 of the mold cavity 140. (See FIG. 9B for an exemplary plug 160 with contour.)

FIG. 10A provides a second plate 120 which has a recessed guide wall. The recessed guide wall may allow the second plate 120 to interact with a first plate 110 having a raised guide wall (see, e.g., FIG. 8A). The disclosure is not limited to this form of interaction of the first plate 110 with the second plate 120. For example, FIG. 10B provides a view of a cross section of a first plate 110 and/or a second plate 120 have no raised guide wall. FIG. 100 demonstrates a variation of a first plate 110 and a second plate 120 in a closed conformation. The first plate 110 and the second plate 120 may interact directly without the implementation of raised and/or recessed guide walls.

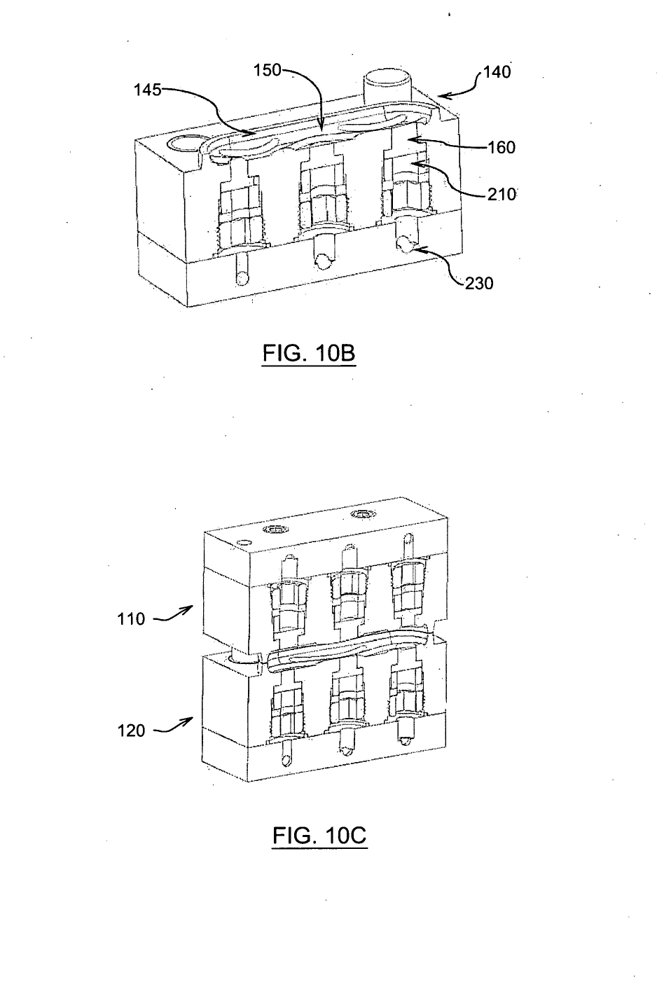

FIGS. 11 through 13 demonstrate a variation of FIGS. 7 through 10. In the variation of FIGS. 11 through 13, at least one ejection orifice may include a combination of a mechanical ejector and air ejection, e.g., via a porous insert. Where a mold cavity has more than one orifice 210, the more than one orifice 210 may be assembled with air ejection orifices (e.g., those demonstrated in FIGS. 1-10), mechanical ejectors, or a combination thereof.

FIG. 11 illustrates a mold cavity 140 with at least three ejection sites. Two of the three ejection sites are air ejection sites as disclosed and described herein. A third ejection site is a mechanical ejection site. The mechanical ejection site includes an ejection pin 1110 (which may be a mechanical ejection pin) assembled with a bushing 1115, which may be a porous guiding bushing. The bushing 1115, and the ejection pin 1110 may precisely conform to the floor 150 of the mold cavity 140. The bushing 1115 may be made of a porous material. Ejection air may pass through the bushing 1115 and provide an additional ejection force on any material present in the mold cavity 140. In this example, the bushing 1115 permits a supply of ejection air around the perimeter of the ejection pin 1110.

In operation, the ejection pin 1110 is capable of moving into the interior space of the mold cavity 140, e.g., by activation of an integral piston 1120 and cylinder 1125, which may be an air cylinder. In a non-limiting variation, air is supplied to cylinder 1125 through air channel 1130. The mechanical contact of the ejection pin 1110 on the molded product, e.g., located in mold cavity 140 provides an additional force to move the molded product away from the mold cavity 140 and into the air flow provided via plugs 160 and bushing 1115, transporting the molded material out of the mold cavity 140.

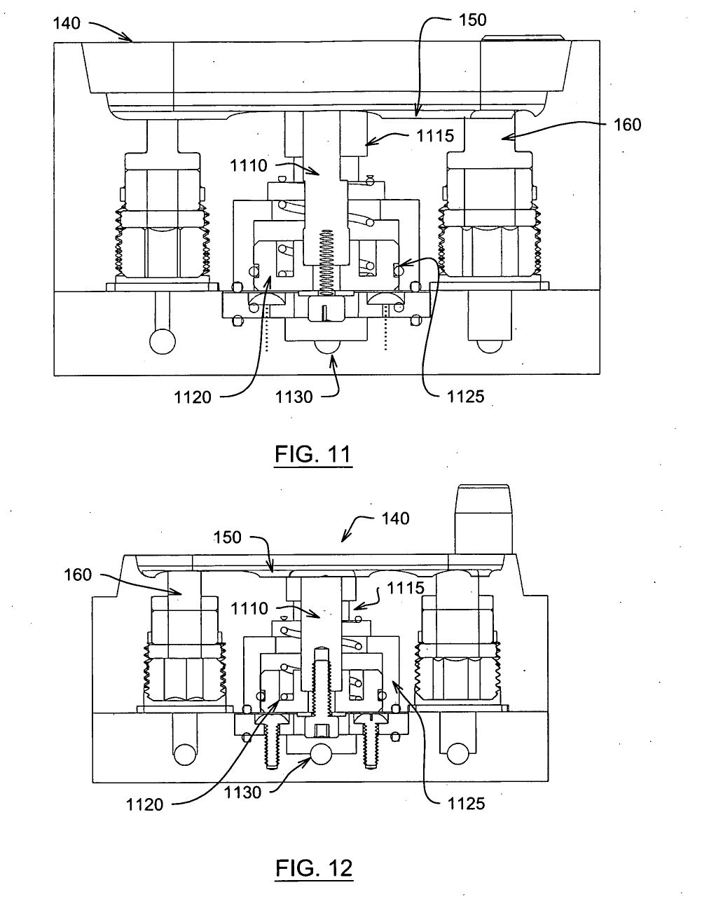

FIG. 12 provides the another version of a mechanical ejector, demonstrating the mechanical ejection site assembled with a mold cavity 140. The mechanical ejection site includes an ejection pin 1110 (which may be a mechanical ejection pin) assembled with a bushing 1115, which may be a porous guiding bushing. The bushing 1115, and the ejection pin 1110 may precisely conform to the floor 150 of the mold cavity 140. The bushing 1115 may be made of a porous material. Ejection air may pass through the bushing 1115 and provide an additional ejection force on any material present in the mold cavity 140. In this example, the bushing 1115 permits a supply of ejection air around the perimeter of the ejection pin 1110.

In operation, the ejection pin 1110 is capable of moving in to the interior space of the mold cavity 140, e.g., by activation of an integral piston 1120 and cylinder 1125, which may be an air cylinder. In a non-limiting variation, air is supplied to cylinder 1125 through air channel 1130. The mechanical contact of the ejection pin 1110 on the molded product, e.g., located in mold cavity 140 provides an additional force to move the molded product away from the mold cavity 140 and into the air flow provided via plugs 160 and bushing 1115, transporting the molded material out of the mold cavity 140.

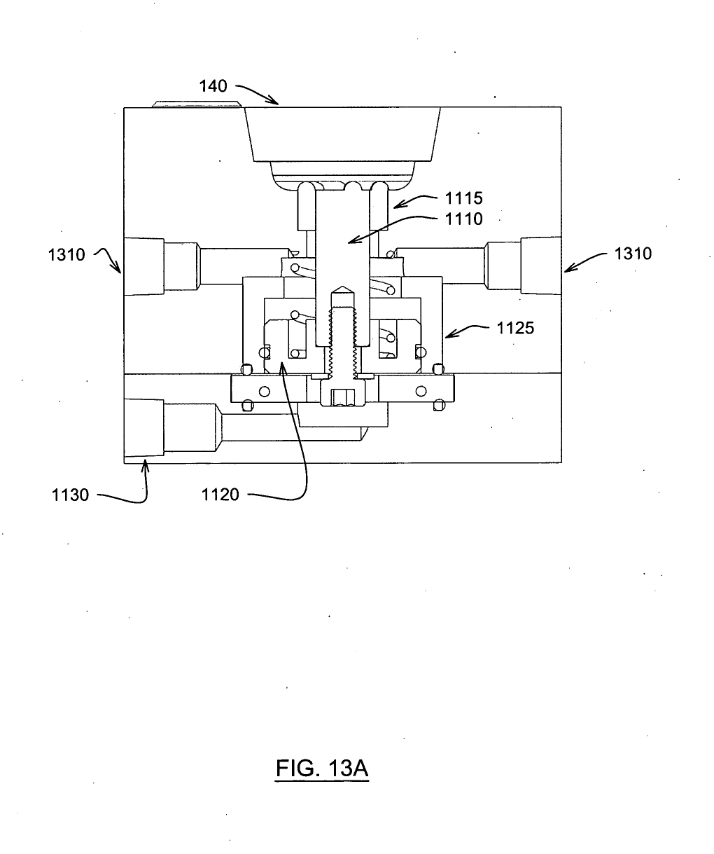

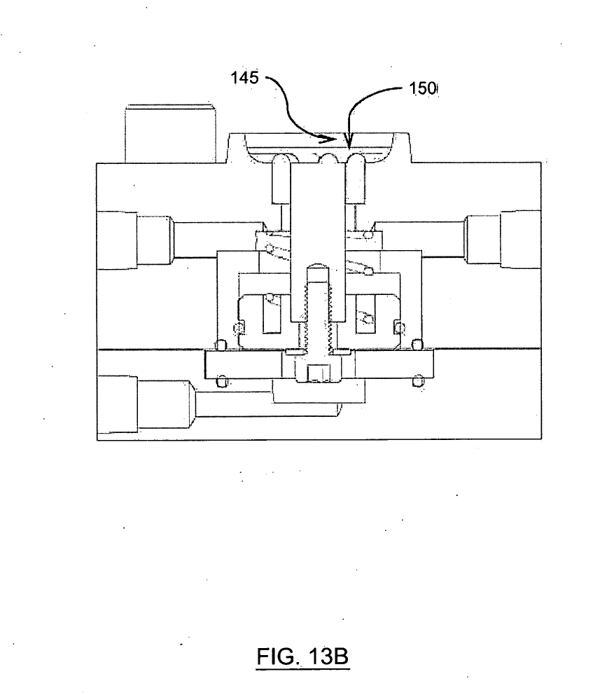

FIG. 13A is a section view of FIG. 11 through the mechanical ejection site taken ninety degrees to the section plane of FIG. 11. In a variation, air is supplied through the channel 1310 to return the piston 1120 and the ejection pin 1110 to a return position following ejection cycle activation. The complementary version of FIG. 13 can be seen in the assembled view of FIG. 14. FIG. 13A provides an example of a mold plate having a recessed guide wall. The disclosure is not limited to mold plates having raised and/or recessed guide walls. This is demonstrated by FIG. 13B which provides a variation of a mold plate assembled with a mechanical ejection device and without a raised and/or recessed guidewall.

FIG. 14 is a section view of a first plate 110 assembled with a second plate 120. The mold cavity 140 of the first plate 110 is assembled with the mold cavity 140 of the second plate 120. In an example operation, air supplied simultaneously through air channel 1130 and channel 1310 provides ejection air through the bushing 1115. In an example, the pressure in channel 1310 may be sufficiently lower than the pressure in air channel 1310 thereby providing a force acting on piston 1120 to move the ejection pin 1110 into the mold cavity 140.

In one exemplary variation the pressure in channel 1310 may be about 50 psi and the pressure in air channel 1130 may be about 100 psi. The channels 1130 and/or 1310 may provide the air flow through bushing 1115 for ejection. An ejection cycle sequence may be activated by supply of air through one or both channels, e.g., with a different in air pressure as described above. An air pressure differential between channel 1130 and channel 1310 may cause the ejection pin 1110 to extend or stroke into the mold cavity 140. After a full stroke of the ejection pin 1110 the air in air channel 1130 may return to 0 psi with the remaining 50 psi in channel 1310 causing ejection pin 1110 and piston 1120 to travel to a return position.

In another exemplary variation, the ejection cycle may supply air pressure first to air channel 1130 and followed by a supply of air pressure to air channel 1300 returning the piston 1120 and ejection pin 1110 to the positions shown in FIG. 14.

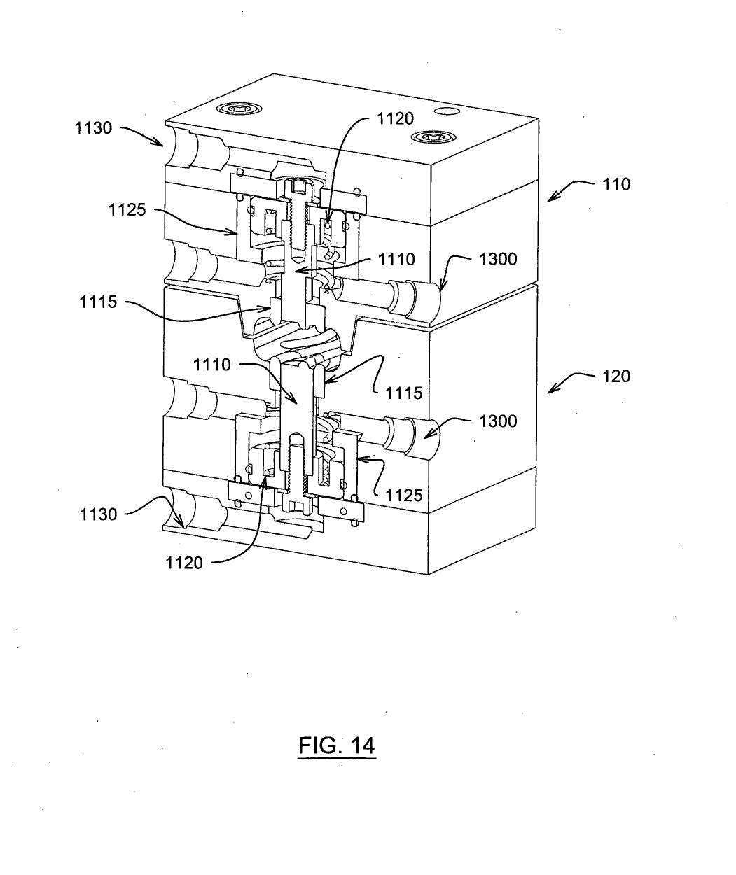

FIG. 15 provides a variation mold plate with ejection technology. The variation of FIG. 15 may be generally referred to as a sample cavity plate 1500. A sample cavity plate 1500 may be implemented to create a product with a design element on one side. The second side of the product may be unadorned. A sample cavity plate 1500 may have a one or more piece construction. The sample cavity plate 1500 may include a body (which may be a planar body) having a mold cavity 1520. The mold cavity 1520 may have the shape of any desired product (e.g., product shape). While one mold cavity 1520 is demonstrated, more than one mold cavity 1520 may be accommodated. The mold cavity may be situated above and in fluid communication with a plenum 1530. Air may be supplied to the plenum 1530 by an air supply channel 1540. In an example, a sample cavity plate 1500 may be a plate of homogenous construction. A porous material may be used to provide ejection force for the ejection of product from the mold cavity 1520. In a variation, the porous material used may have the additional quality of having a non-porous surface that becomes porous only when and to the extent that it is machined (e.g., milled or engraved). For example, the surface may be non-porous but the entire region representing the mold cavity 1520 may be porous.

The variation of FIG. 15A, demonstrates an example in which the entire mold cavity 1520 is porous and allows air to pass from the plenum 1530 beneath. It should be understood that any mechanism described herein may be implemented on the sample cavity plate 1500. For example, the mold cavity 1520 may be solid with and implement porous plugs as described in FIGS. 1-9.

FIG. 15B shows a sample cavity may have a surface plate 1550 and a base plate 1560. The surface plate 1550 and base plate 1560 are shown separately for convenience and to illustrate a variation, however, it should be understood that the surface plate 1550 and base plate 1560 may be unified into a solitary device or broken further into multiple layers.

In an exemplary operation, a product dough may be applied to the mold cavity 1520. The product dough may be smoothed to the top surface plane of the sample cavity plate 1500, e.g., with a spatula or equivalent tool. Air may me supplied to the mold cavity 1520 through channel 1540. The channel 1540 may be in fluid communication with the plenum 1530, which may direct the air under and through the mold cavity 1520. The porosity of the mold cavity 1520 allows a uniform pressure to act on the molded product with a force that ejects the product from the mold cavity 1520.

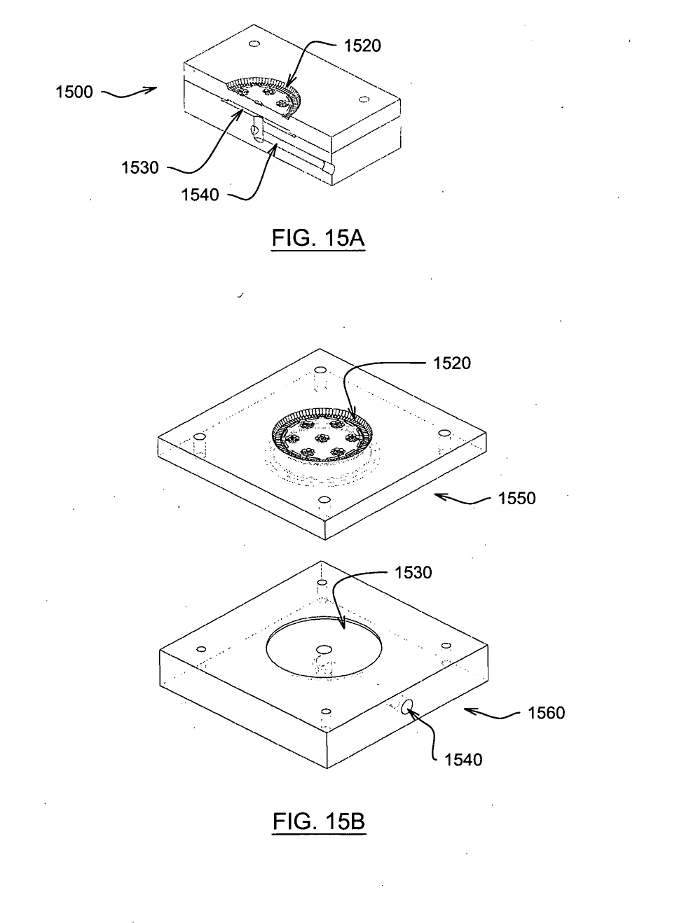

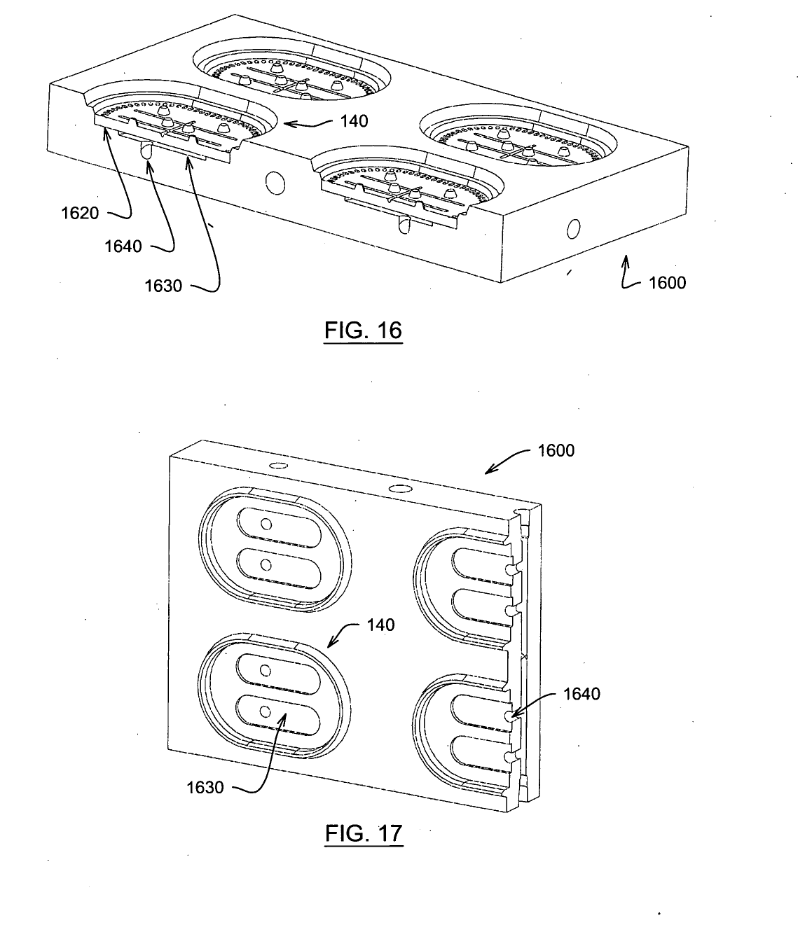

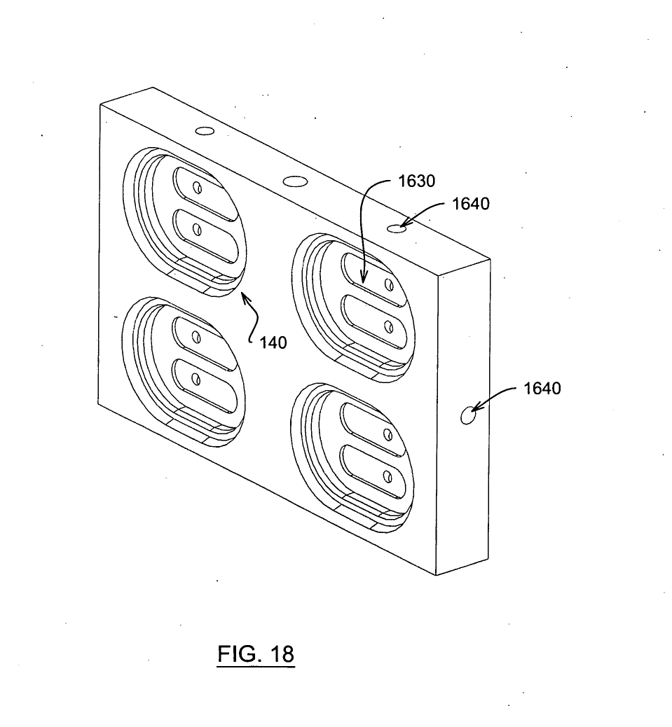

FIG. 16 provides a variation of the mold designs of FIGS. 1-9. A mold plate 1600 may have a mold cavity 140 therein. The mold cavity 140 may be assembled with a porous insert, which may be a machined insert 1620. The machined insert 1620 may be engineered to follow the full contour of the mold cavity 140. In a variation, the machined insert 1620 may substantially cover the floor of the mold cavity 140. The machined insert 1620 may have surface adornments desired to be imparted to a molded product. The machined insert 1620 may be situated above a plenum 1630. The plenum 1630 may direct air pressure from an air channel 1640 to the machined insert 1620. FIGS. 17 and 18 illustrate the mold plate 1600 with the machined inserts 1620 removed.

The ejection technology may greatly enhance release of consumables from a mold. This may reduce the need for release coatings, lubricants, and otherwise. For example, when a product is not released and/or ejected, e.g., due to dough sticking, a next cycle may start with a full or partially full cavity. When additional dough is placed into a cavity in the next cycle, it may create a product defect as the mold closes. The defect may be disfiguration of a product. Good ejection may reduce or eliminate such defects.

The ejection technology may reduce the frequency of maintenance. It may increase efficiency and reduce costs related to manufacturing. The technology may be implemented without the need for moving parts within the mold plate. For example, it may be implemented without such common moving parts as ejection pins, O-rings, shakers, mechanical knock out devices, and otherwise. The reduction of moving parts may reduce both the incidence of maintenance needs and reduce the surfaces on which food materials may be caught (e.g., reducing fouling).

While variations of the invention have been described, it will be apparent to those of skill in the art that many more implementations are possible that are within the scope of the claims.

1. A molding tool comprising:
a first plate;
the first plate having a surface;
the surface comprising a mold cavity;
the mold cavity having a side wall and a bottom wall;
the mold cavity having an orifice defining an opening through the bottom wall of the cavity;
the orifice assembled with a porous insert.

2. The molding tool of claim 1, the porous insert is a plug assembled in the orifice.

3. The molding tool of claim 1 further comprising a distribution channel, the distribution channel in fluid communication with the orifice.

4. The molding tool of claim 1, further comprising a mechanical ejection site, the mechanical ejection site comprising an ejection pin assembled with a bushing; and the bushing made of a porous material.

5. The molding tool of claim 1, further comprising a temperature regulation channel.

6. A molding tool of claim 1, further comprising:
the porous insert situated above a plenum; and
the plenum in fluid communication with an air channel.

7. The molding tool of claim 1, further comprising a second plate;
the second plate having a surface;
the surface comprising a mold cavity;
the mold cavity having a side wall and a bottom wall;
the mold cavity having an orifice defining an opening through the bottom wall; and
the orifice assembled with a porous insert.

8. The molding tool of claim 7, further comprising a distribution channel, the distribution channel in fluid communication with the orifice.

9. The molding tool of claim 7, further comprising a mechanical ejection site, the mechanical ejection site comprising an ejection pin assembled with a bushing; and the bushing made of a porous material.

10. The molding tool of claim 7, further comprising a temperature regulation channel.

11. A molding tool of claim 7, further comprising:
the porous insert situated above a plenum; and
the plenum in fluid communication with an air channel.

12. The molding tool of claim 11, further comprising a second plate;
the second plate having a surface;
the surface comprising a mold cavity;
the mold cavity having a side wall and a bottom wall;
the mold cavity having an orifice defining an opening through the bottom wall;
the orifice removably assembled with a porous insert;
the porous insert situated above a plenum; and
the plenum in fluid communication with an air channel.

13. The molding tool of claim 11, further comprising:
the first plate and the second plate assembled such that the mold cavity of the first plate aligns with the mold cavity of the second plate.

14. A sample cavity plate comprising:
a body;
the body having a planar surface;
the planar surface having a mold cavity therein;
the mold cavity having a product shape;
the mold cavity comprising a porous material;
the mold cavity situated above and in fluid communication with a plenum; and
the plenum in fluid communication with an air channel.

15. The sample cavity plate of claim 18 further comprising:
the body comprising a surface plate and a base plate;
the surface plate comprising the mold cavity;
the base plate comprising the plenum and the air channel; and
such that when the surface plate and the base plate are assembled, the plenum is situated beneath the mold cavity.
